(19) United States
(12) Patent Application Publication
(10) Pub. No.: US 2006/0015883 A1
(43) Pub. Date: Jan. 19, 2006

(54) Method and device for removing and inserting a disk from and into a stack of disks from below

(75) Inventors: Thomas Kern, Obererdingen (DE); Jochen Gutscher, Illingen (DE); Bernd Mahner, Muhlacker (DE); Roland Wagner, Bretten (DE)

Correspondence Address: ROBERT W. BECKER & ASSOCIATES, 707 HIGHWAY 66 EAST, SUITE B, TIJERAS, NM, 87059, US

(73) Assignee: STEAG Hama Tech AG, Sternenfels (DE)

(21) Appl. No.: 10/538,676

(22) PCT Filed: Nov. 28, 2003
(86) PCT No.: PCT/EP03/13386

§ 371 Date: Jun. 10, 2005

(30) Foreign Application Priority Data
Dec. 18, 2002 (DE) 102 59 378.7

(51) Int. Cl. G11B 33/02

(52) U.S. Cl. 720/600

(57) ABSTRACT

A method and device for extracting at least one plate from, and/or inserting one plate into, a stack of plates from below. At least two rests are provided for supporting the stack of plates. The rests are moved horizontally out of and/or into the range of the stack of plates. For each extraction and/or insertion process, the stack of plates is rotated through a prescribed angle of rotation, with such rotational movement being combined with the horizontal movement of the rests.

The invention relates to a method of extracting at least one plate from a stack of plates from below, and also to a method of inserting a plate into a stack of plates from below. Furthermore, the invention relates to a device for extracting a plate from a stack of plates from below, and for inserting a plate into a stack of plates from below.

When processing or fabricating plates, for example when processing and fabricating optical data carriers such as CDs or DVDs, it is necessary or advantageous to arrange the plates in the form of a stack of plates and to process them in this form, for example by subjecting them to a cooling or heating medium such as cooling or hot air, in order to treat the entire surface of the plates in as uniform a manner as possible, such as by cooling or heating them. Processing items in the form of a stack is therefore advantageous, inter alia, because such a stack has a very small surface area and only occupies a small amount of space in contrast to a treatment involving items on a moving belt or some other form of horizontal transportation system.

Consequently, when treating or processing plates arranged in the form of a stack, the object of the invention is to provide a simple but nevertheless reliable manner of extracting the plates from and inserting the plates into the stack of plates.

In accordance with one aspect of the invention, this object is achieved by means of a method which comprises the following method steps:
a) supporting the stack of plates with the aid of at least two rests upon the boundary regions of which the lowest plate of the stack of plates rests,
b) raising the stack of plates so that the rests are freed from the lowest plate,
c) moving the rests horizontally out of the range of the stack of plates,
d) lowering the stack of plates to such an extent that the rests are located at a position between the lowest plate and the neighboring plate thereabove,
e) moving the rests horizontally into the gap between the lowest plate and the neighboring plate thereabove, and
f) further lowering the stack of plates until the second lowest plate rests upon the rests.

The object posed is achieved in the case of a method of inserting a plate into a stack of plates from below by the following method steps:
g) transporting the plate that is to be inserted under the stack of plates,
e) raising the plate that is to be inserted until the stack of plates rests upon the plate that is to be inserted,
f) further raising the plate that is to be inserted and the stack of plates resting thereupon so that the lowest plate of the stack of plates is freed from the rests supporting the stack of plates,
g) moving the rests horizontally out of the range of the stack of plates,
h) further raising the plate that is to be inserted together with the stack of plates resting thereupon until the rests are located at a position below the plate that is to be inserted,
i) moving the rests horizontally under the plate that is to be inserted, and
k) lowering the plate that is to be inserted and the stack of plates resting thereupon until it rests upon the rests.

By virtue of the measures in accordance with the invention, it is possible to reliably extract plates from a stack of plates and reliably supply plates to a stack of plates in a simple manner. Hereby, an embodiment that is particularly advantageous is one in which both the method steps a) to f) for the extraction of the plates and the method steps g) to k) are carried out by means of the same device.

In one advantageous embodiment of the method in accordance with the invention, the rests are moved out of the range of the stack of plates when a plate is raised or lowered past them. Consequently, each of the plates that is to be inserted or extracted does not collide with the rests which are provided for the purposes of holding and supporting the stack of plates.

In accordance with a particularly advantageous embodiment of the invention, the stack of plates is rotated through a given angle of rotation, for example through 30°, during each extraction and/or insertion process. If, in each case, this rotation is effected in one direction of rotation, then a total rotation of the stack through 360° will result after the processes of extracting and inserting a plate have been repeated 12 times in the case of a step-by-step rotation through 30°. This rotational process, for which additional active drives are necessary, enables each side of the stack and the plates to be treated uniformly when the plates in the stack of plates are subjected to a processing medium, a stream of coolant for example thereby ensuring uniform treatment of all the plates within the stack of plates.

A further preferred embodiment of the method in accordance with the invention consists in the rotational movement being combined with the horizontal movement of the rests into and/or out of the range of the stack of plates. Thus, in accordance with this embodiment, the horizontal movement of the rests is caused by the rotational movement. It is also advantageous to effect and/or combine the horizontal movement of the rests with the raising and/or the lowering of the plate that is to be inserted or extracted. In addition thereby, active actuation of the rests and hence a separate driver device therefor is not necessary for the movement of the rests.

A further preferred embodiment of the method in accordance with the invention consists in the insertion of a plate that has been extracted from a first stack of plates into a neighboring stack of plates. In this way, it is possible for the plates in one stack of plates to be transported downwardly from the top and then transported upwardly from the bottom in a neighboring stack of plates so that a kind of plate circulation process thereby ensues. For the purposes of supplying plates that are to be inserted into the stack of plates and for removing plates that have been extracted from the stack of plates, the plates are preferably transported horizontally. In the case of the embodiment wherein a plate that has been extracted from one stack of plates is then inserted into a neighboring stack of plates, the plate that is initially extracted and is then to be re-inserted is transported horizontally from the first stack of plates to the second stack of plates below the stack of plates by means of a conveyor belt for example.

Furthermore, in the case of a device for extracting a plate from a stack of plates from below and for inserting a plate into a stack of plates from below, the posed object is achieved by means of at least one lifting device for vertically raising and lowering a plate and/or a stack of plates and by means of at least two plate supporting devices each of which comprises at least one rest for supporting the plates or the stack of plates. Accordingly, the extraction of a plate from a stack of plates and the insertion of a plate into a stack of plates is effected by the same device so that the cost of the device and in particular the maintenance cost thereof is low due to the low outlay for the device and the small number of components.

The lifting device preferably comprises a plate seating means which is rotatable through a given angle of rotation. By virtue of this measure, it is possible for the entire stack of plates to be rotated in a step-by-step manner through a certain angle of rotation prior to, during or after the extraction or insertion of a plate in order to thereby enable—as has already been mentioned—the plates within the stack to be treated in a uniform manner.

In accordance with one advantageous embodiment, the plate seating means has a horizontal cam profile.

In accordance with a further embodiment of the invention, the rest in the plate supporting device has a vertical cam profile which cooperates with the horizontal cam profile on the plate seating means. By virtue of the cam profiles, the horizontal movement of the rest is effected merely by the rotation of the plate seating means and/or the raising or lowering thereof so that the rest is located outside the stack of plates or the plate radius while the plate that is to be inserted or extracted passes by.

The plate supporting device, which thus represents a passive control system without additional driver devices for the horizontal movement of the rest in this exemplary embodiment, preferably comprises a biasing device, a weight or a spring for example with the aid of which the vertical cam profile of the rest is pressed onto the horizontal cam profile of the plate seating means.

In accordance with a further very advantageous embodiment of the invention, the control surface of the horizontal cam profile is formed in such a way that it presses the rest, against the effect of the biasing device, radially outward and out of the range of the stack of plates when the plate seating means is rotated in a first direction of rotation, and permits a controlled horizontal movement of the rest into the region of the stack during a rotation of the plate seating means in the opposite direction of rotation.

It is advantageous if the control surface of the vertical cam profile is formed in such a way that, after the extraction of a plate, the rest is movable radially inward into the region of the stack during the lowering of the lifting device, and is movable radially outward from the stack for the purposes of inserting a plate during the raising of the lifting device. In this way, it is ensured that the rest is located outside the plate radius during the passage of a plate but is nevertheless back again under the stack of plates at a given time for the purposes of supporting it without the need for an additional or specific active control means for the plate supporting device.

A further advantageous embodiment of the device in accordance with the invention consists of a horizontal conveyor belt for the horizontal transportation of the plates extracted from a stack of plates and/or the plate that is to be inserted under a stack of plates. Hereby, it is advantageous if the conveyor belt is formed in such a way that the lifting device is movable right through the conveyor belt so that the plate seating means thereof picks up the plate from the conveyor belt during the raising process and deposits the plate on the conveyor belt during the plate extraction process.

In accordance with a further very advantageous embodiment of the invention, there are provided at least two stacks of plates which are arranged next to one another. Hereby, it is particularly advantageous if the lifting devices comprise a common stroke-type driver device and/or if the plate seating means of the at least two lifting devices comprise a common rotary-type driver device.

Particularly in connection with the transportation of discs or substrates, for example of CDs or DVDs, the plates are in the form of pallets for accommodating such discs or substrates. In order to avoid repetition in regard to such plates in the form of pallets, reference is made to the German Application No. 101 62 957 from the same Applicants whose subject matter is, to this extent, incorporated in the present Application.

In this case, the central portions of the plates comprise a vertical upwardly projecting stud for centering purposes. Preferably-as described in the previously mentioned patent application-the outer regions of the plates in the stack of plates are mutually spaced. The discs or substrates are preferably optical data carriers such as CDs or DVDs.

One embodiment of the device in accordance with the invention is very advantageous, wherein the stack of plates is arranged in a cylinder in which the plates, pallets and/or discs are subjected to a processing stream, for example a cooling medium or a hot-air stream.

The invention is described more fully hereinafter on the basis of preferred exemplary embodiments taken with reference to the Figures, in which:

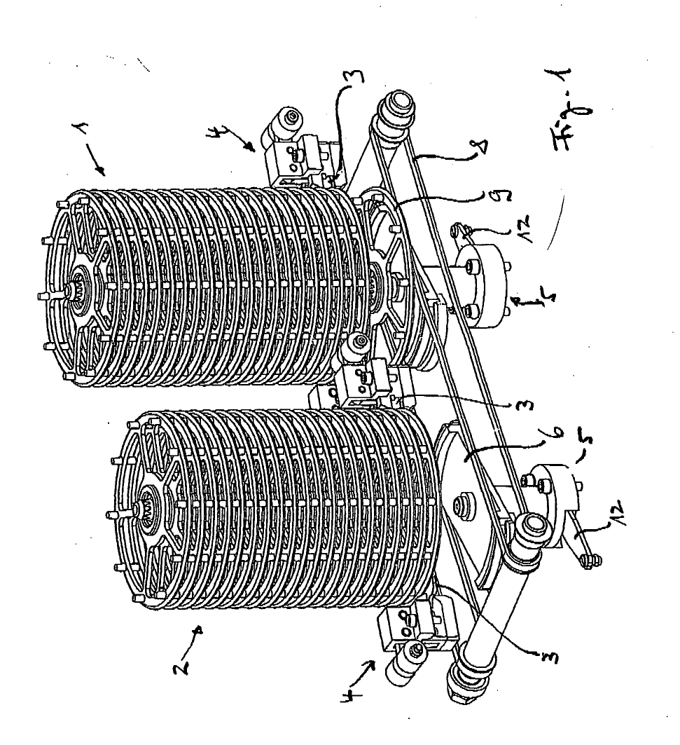

FIG. 1 shows a schematic perspective illustration of the entire system, but without a drive device for a plate lifting device,

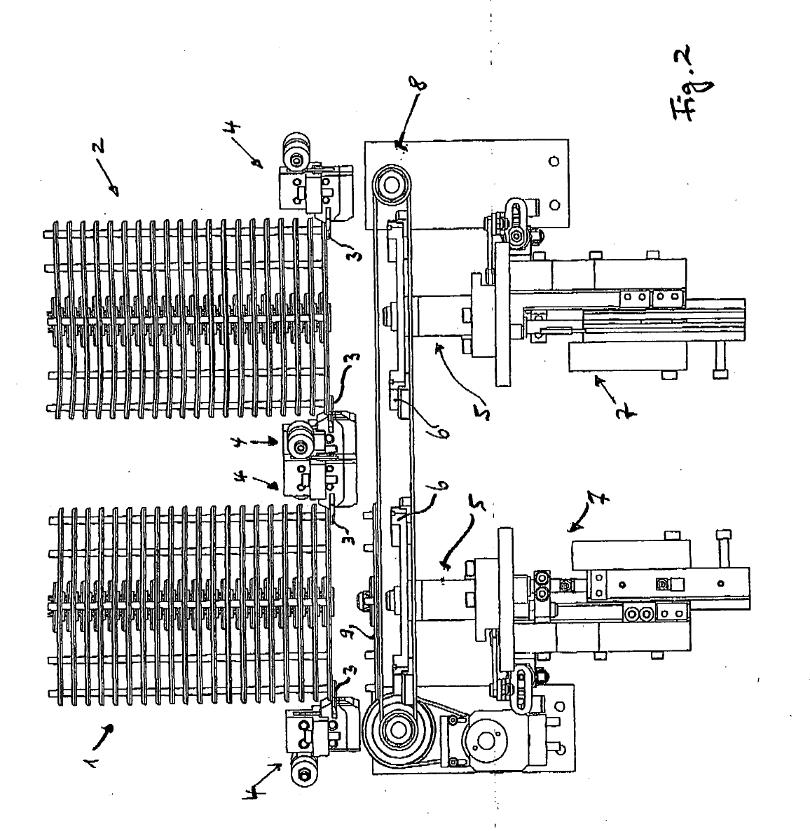

FIG. 2 shows a side view of the device illustrated in FIG. 1 including a drive device for the lifting device,

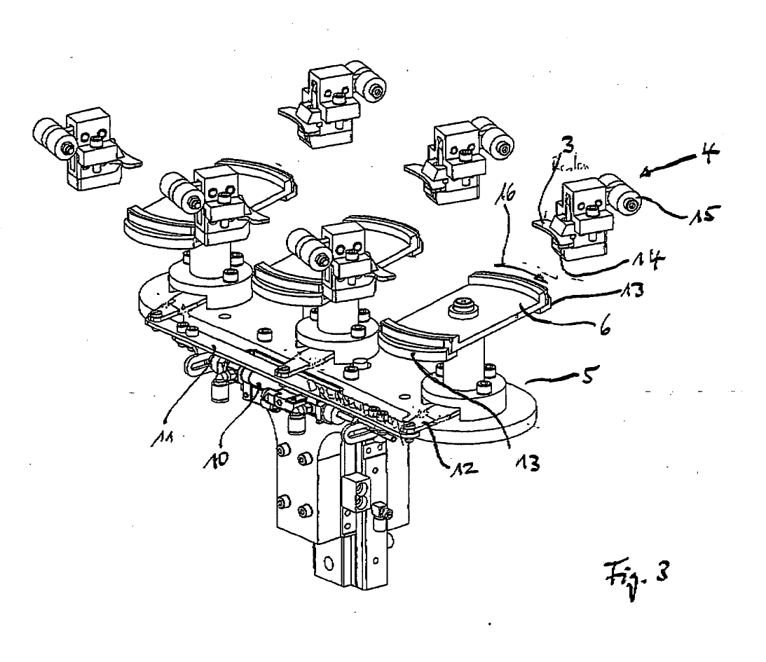

FIG. 3 shows a schematic perspective view of parts of the device illustrated in FIGS. 1 and 2 for explaining the lifting device and the plate supporting device as well as the functioning and patterns of movement thereof,

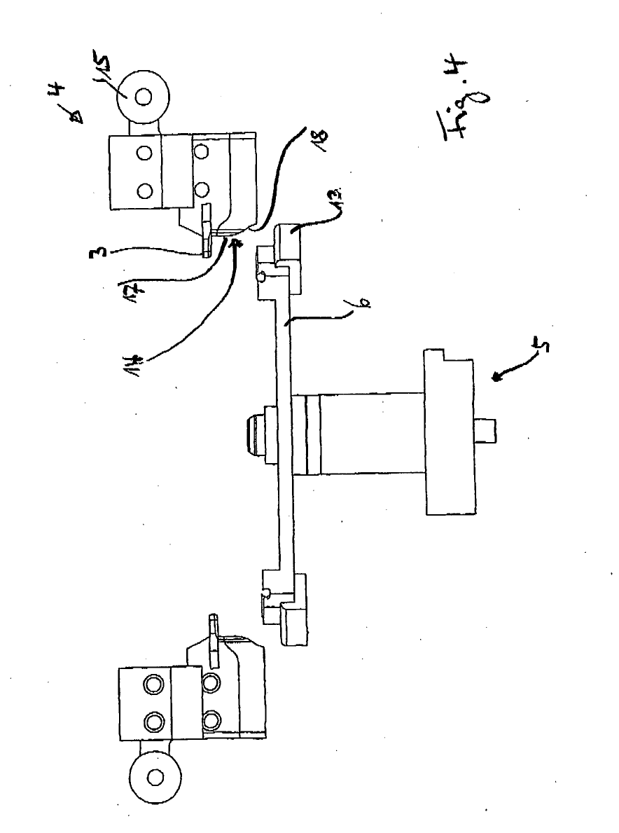

FIG. 4 shows a schematic side view of the lifting device and the plate supporting device in the lowered basic position of the lifting device, with the rests in the locked position,

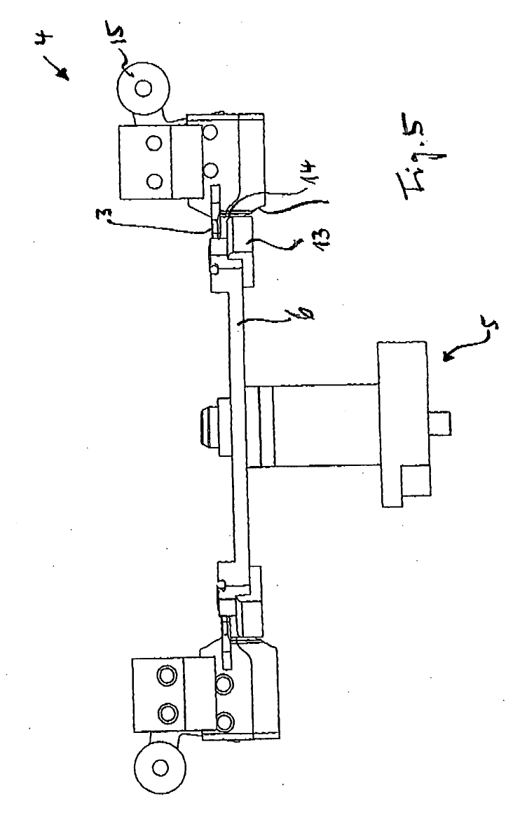

FIG. 5 shows the view illustrated in FIG. 4, but in the raised basic position of the lifting device, with the rests in the unlocked position,

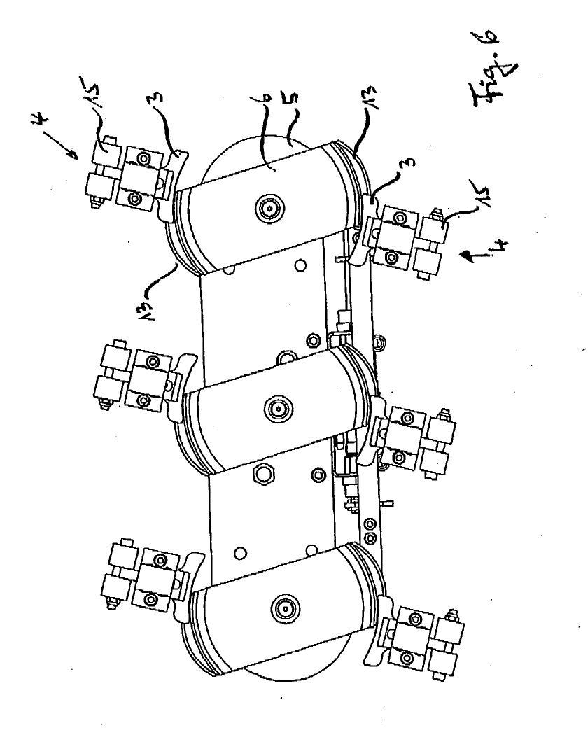

FIG. 6 shows a plan view of the lifting device and the plate supporting device wherein the rests are in the locked position, and

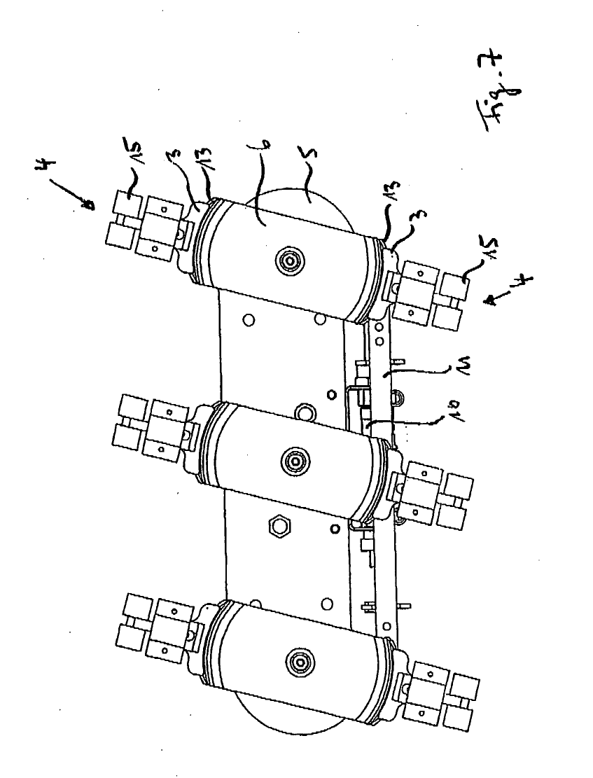

FIG. 7 shows an illustration corresponding to FIG. 6 wherein the rests are in the unlocked position.

In the case of the exemplary embodiments illustrated in FIGS. 1 and 2, two stacks of plates 1, 2 are arranged next to one another. The stacks of plates rest upon the rests 3 of the plate supporting devices 4. A respective lifting device 5, which is adapted to be raised and lowered by means of a drive device 7 and includes a plate seating means 6, is provided below each stack of plates.

A conveyor belt 8, with the aid of which a plate 9 that is to be extracted or inserted is transportable horizontally under the stack of plates 1, is located below the stack of plates 1, 2. The conveyor belt 8 comprises openings through which the plate seating means 6 passes freely when the lifting device 5 is raised and lowered. The plate seating means 6 therefore lifts up the plate 9 that is to be inserted from the conveyor belt during the raising process, and places the plate 9 that is to be extracted on the conveyor belt 8 during the lowering process.

The lifting devices and the plate supporting devices 4, 6 as well as the details thereof are described hereinafter with the aid of FIGS. 3 to 7.

In the exemplary embodiment illustrated, there are three identical lifting devices and plate supporting devices which are provided for three not shown stacks of plates located thereabove and are arranged in parallel next to one another. For the sake of clarity, only one lifting device and one plate mechanism are provided with reference symbols and only the details and the functioning thereof are explained in the following.

The plate seating means 6 is rotatable back and forth through an angle of 30° via a movable rail 11 and an arm 12 by means of a cylinder 10 and, at the outer region thereof, each seating means has a horizontal cam profile 13.

Each plate supporting device incorporating a rest 3 has a vertical cam profile 14, as is best seen in FIGS. 4 and 5. The rest 3 having the vertical cam profile 14 thereon is biased inwardly by means of a weight 15.

The functioning of this exemplary embodiment in regard to the extraction of a plate 9 from below the stack of plates 2 will now be described hereinafter.

In the starting position, the stack of plates 2, i.e. the lowest plate thereof, rests upon the rests 3, as is best seen in FIGS. 1 and 2. In this state, the lifting device 5 is raised so that the plate seating means 6 engages under the lowest plate in the stack of plates 2 and thereby raises the entire stack of plates 2 so that it no longer rests on the rests 3. Thereafter, the plate seating means 6—and thus the entire stack of plates—is rotated in one direction of rotation by means of the pneumatic cylinder 10, the rail 11 and the arm 12, as is indicated by the arrow 16. Since the vertical cam profile 14 of the plate supporting device 4 rests against the horizontal cam profile 13 and the plate seating means 6 due to the weight 15, the rest 3 will be pressed outwardly in the course of this rotation due to the radial camming action of the horizontal cam profile 13 so that the rest 3 is no longer situated within range of the stack of plates 2. In this state, the lifting device 5 together with the plate seating means 6 is lowered so that, in the position to which it has previously been rotated, the horizontal cam profile 13 slides downwardly on the vertical cam profile 14 of the plate supporting device, as is best seen in FIGS. 4 and 5. The vertical cam profile 15 has a perpendicular profiled portion 17 and an S-shaped profiled portion 18 which adjoins the perpendicular profiled portion 17 at the lower end thereof. When the lifting device 5 is lowered, the horizontal cam profile 13 slides on the vertical cam profile 14, initially perpendicularly downwards along the perpendicular profiled portion 17 and then on the adjoining S-shaped profiled portion 18 whose spacing from the central axis of the lifting device 5 increases in the downward direction. Consequently, the lowest plate in the stack of plates arrives at a position below the rest 3 which then re-enters the region covered by the stack of plates below the next higher plate due to the curvature of the S-shaped profiled portion 18. The remaining stack of plates is re-seated on the rest 3 when the plate seating means 6 is lowered still further. The lifting device 5 continues to be driven downwardly and the plate 9 that has been extracted from the stack of plates is deposited on the conveyor belt 8.

The process of inserting a plate into a stack of plates runs in the reverse order to the previously described sequence for extracting a plate therefrom. The plate seating means 6, which is located below the conveyor belt 8 in the basic position, is raised by the lifting device 5, lifts up the plate 9 that is to be inserted from the conveyor belt 8 and raises it under the stack of plates 1. As the lifting device 5 is raised still further, the stack of plates 1 is lifted up over the plate 9 that is to be inserted so that the stack of plates 1 is freed from the rest 3 of the plate supporting device 4. The horizontal cam profile 13, which slides on the vertical cam profile 15 in the course of this raising process, presses the rest 3 outwardly due to the camming action of the vertical cam 15, i.e. due to the S-shaped profiled portion 18, so that the plate 9 that is to be inserted can be raised upwardly past the rest 3. In this state, the plate seating means 6 is rotated in the opposite direction to that of the arrow 16 so that the vertical cam profile 15 slides on the horizontal cam profile 13. Since the radius of the horizontal cam profile 13 becomes smaller with respect to the axis of rotation during the rotational process, the rest 3 re-enters the region covered by the stack of plates and moves below the plate that is to be inserted, which is now the lowest plate in the stack of plates. By lowering the lifting device 5, the stack of plates is seated once again on the rest 3 and thus the process of inserting a plate 9 into the stack of plates I is terminated.

Thereafter, the plate seating means 6 is returned to the basic position in a direction opposite to the direction of rotation of the arrow 16 (see FIG. 3).

As is apparent from FIGS. 1 and 2, in the case of the exemplary embodiment illustrated, a plate is extracted from a first stack of plates 2, is transported by means of the conveyor belt 8 to the neighboring stack of plates 1, and there is inserted into the neighboring stack of plates 1.

As is apparent from the exemplary embodiment described, the same device is usable both for extracting a plate from, and inserting a plate into, a stack of plates 1, 2, since the constructional characteristics of the device are identical for both processes. This enables one to have a simple construction incorporating just a few components and low maintenance costs. Due to the step-by-step rotation of the plate seating means 6 through e.g. 30° on each occasion for each insertion or extraction of a plate, an auxiliary function in the form of a rotation of the entire stack of plates is carried out, this being particularly advantageous for providing uniform treatment of the stack, for example in a cooling or heating cylinder.

In the case of the embodiment illustrated, the dead weight of the stack of plates 1, 2 is sufficient to achieve adequate friction for the stack to be rotated therewith during the rotation of the plate seating means 6. However, it is also possible to provide e.g. a toothed assembly or O-rings between the individual plates so as to obtain a frictional driving arrangement in order to ensure that the plates also rotate during the rotational process. In order to avoid repetition regarding the pallets which can be used in connection with the present invention, reference is made to the previously mentioned German patent application No. 101 62 957 from the same Applicants.

The present invention has been described on the basis of preferred exemplary embodiments. However, variations, other designs and modifications are possible for the skilled person without thereby departing from the inventive concept.

1-25. (canceled)

26. A method of extracting at least one plate from, and/or inserting at least one plate into, a stack of plates from below, including the steps of
providing at least two rests for supporting the stack of plates;
horizontally moving the rests out of and/or into the of the stack of plates; and
for each extraction and/or insertion process, rotating the stack of plates through a prescribed angle of rotation, wherein such rotational movement is combined with the horizontal movement of the rests.

27. A method according to claim 26 for extracting at least one plate from a stack of plates from below, including the steps of:
a) supporting the stack of plates with at least two of the rests, wherein a lowermost plate of the stack of plates rests on rim portions of the rests;
b) raising the stack of plates such that the rests are freed from said lowermost plate;
c) horizontally moving the rests out the range of the stack of plates;
d) lowering the stack of plates to such an extent that the rests are disposed at a level between said lowermost plate and a plate disposed thereabove.
e) horizontally moving the rests into a space between said lowermost plate and that plate disposed thereabove; and
f) lowering said stack of plates further until a second lowermost plate rests

28. A method according to claim 26 for inserting a plate into a stack of plates from below, including the steps of:
g) transporting the plate that is to be inserted below the stack of plates;
h) raising the plate that is to be inserted until the stack of plates rests thereupon;
i) raising the plate that is to be inserted, and the stack of plates resting thereupon, further such that a lowermost plate of a stack of plates is freed from the rests that support the stack of plates;
j) horizontally moving the rests out of the range of the stack of plates;
k) further raising the plate that is to be inserted, together with the stack 1 of plates resting thereupon, until the rests are disposed at a level below the plate that is to be inserted;
l) horizontally moving the rests 3 below the plate that is to be inserted; and
m) lowering the plate that is to be inserted and the stack of plates resting thereupon, until it rests upon the rests.

29. A method according to claim 26, which includes providing a single device for both an extraction as well as an insertion process.

30. A method according to claim 26, wherein said rests are moved out of the range of said stack of plates when a plate is raised or lowered past said rests.

31. A method according to claim 26, wherein a plate extracted from a first stack of plates is inserted into an adjacent stack of plates.

32. A method according to claim 26, wherein an extracted plate and/or a plate that is to be inserted is transported horizontally.

33. A device for extracting a plate from, and inserting a plate into, a stack of plates from below, comprising:
at least one lifting device for vertically raising and lowering a plate and/or a stack of plates, wherein said at least one lifting device is provided with a plate seating means that is rotatable through a prescribed angle of rotation, and wherein said plate seating means has a horizontal cam profile; and
at least one plate supporting device having at least two rests for supporting the plates or the stack of plates.

34. A device according to claim 33, wherein the rests of the plate supporting device have a vertical cam profile that cooperates with the horizontal cam profile of the plate seating means.

35. A device according to claim 34, wherein the plate supporting device is provided with a biasing device for pressing the vertical cam profile against the horizontal cam profile of the plate seating means.

36. A device according to claim 35, wherein the biasing device 15 is a weight or a spring.

37. A device according to claim 35, wherein a control surface of the horizontal cam profile is formed such that upon rotation of the plate seating means in a first direction of rotation, the control surface presses the biasing device radially upwardly and out of the range of the stack of plates, and upon rotation of the plate seating means in a further direction of rotation, the control surface permits a controlled horizontal movement of the rests radially inwardly into the range of the stack of plates.

38. A device according to claim 34, wherein a control surface of the vertical cam profile is formed such that upon lowering of the at least one lifting device, the control surface is movable radially inwardly into the range of the stack of plates, and upon raising of the lifting device, the control device is movable radially outwardly out of the range of the stack of plates.

39. A device according to claim 33, wherein a horizontal conveyor belt is provided for transporting an extracted plate and/or a plate that is to be inserted.

40. A device according to claim 33, wherein at least two stacks of plates are provided, each with at least one lifting device and at least two plate supporting devices.

41. A device according to claim 40, wherein the lifting devices are provided with a common stroke-type driver device.

42. A device according to claim 40, wherein the plate seating means of the at least two lifting devices are provided with a common rotary-type driver device.

43. A device according to claim 33, wherein the plates 9 are in the form of pallets for accommodating disks or substrates.

44. A device according to claim 33, wherein central portions of the plates 9 are provided with a vertically upwardly projecting stud that, in the stack of plates, centers a plate disposed above the first mentioned plate.

45. A device according to claim 33, wherein outer portions of plates in a stack of plates are spaced from one another.

46. A device according to claim 43, wherein the disks are optical data carriers.

47. A device according to claim 43, wherein the stack is disposed in a cylinder in which the plates, pallets and/or disks are subjected to a stream of treatment medium, in particular a cooling medium.
